(19) United States
(12) Patent Application Publication
(10) Pub. No.: US 2026/0017730 A1
(43) Pub. Date: Jan. 15, 2026

(54) METHOD FOR MATCHING CROP AND LIVESTOCK AND POULTRY PRODUCTION IN THE SAME REGION BASED ON COMBINATION OF PLANTING AND BREEDING

(71) Applicant: Institute of Environment and Sustainable Development in Agriculture, CAAS, Beijing (CN)

(72) Inventors: Qingwen Zhang, Beijing (CN); Yulong Shi, Beijing (CN); Li Zheng, Beijing (CN)

(21) Appl. No.: 18/803,309

(22) Filed: Aug. 13, 2024

(30) Foreign Application Priority Data
Jul. 9, 2024 (CN) 202410910024.4

(51) Int. Cl. G06Q 50/02; A01G 7/00; A01K 29/00; G06Q 10/0637

(52) U.S. Cl. CPC G06Q 50/02; A01G 7/00; A01K 29/005; G06Q 10/0637

(57) ABSTRACT

A method for matching crop and livestock and poultry production in the same region based on the combination of planting and breeding is provided, including determining crop varieties suitable for planting and livestock and poultry species suitable for breeding based on climate data, soil characteristics, and water resource information of a region to be matched; determining planting and breeding plans based on physiological needs and growth cycles of crop varieties and livestock and poultry species; designing spatial layout based on the planting and breeding plans, and establishing organic connections between crops and livestock and poultry; during the production process, monitoring growth status of crops and livestock and poultry in real-time, and adjusting the planting and breeding plans based on the growth status. By optimizing resource allocation, improving resource utilization, and reducing environmental pollution, a new path for sustainable development has been provided for agricultural production.

### CROSS-REFERENCE TO RELATED APPLICATIONS

This application claims to the benefit of priority from Chinese Application No. 202410910024.4 with a filing date of July 9, 2024. The content of the aforementioned applications, including any intervening amendments thereto, are incorporated herein by reference.

### TECHNICAL FIELD

The present invention relates to the technical field of agriculture, in particular to a method for matching crop and livestock and poultry production in the same region based on combination of planting and breeding.

### BACKGROUND

The combination of crop planting and livestock and poultry breeding is one of the important directions for the development of modern agriculture. It achieves efficient utilization of resources and protection of the ecological environment by reasonably combining of planting and breeding. However, the traditional model of combination of planting and breeding often suffers from a mismatch between crop and livestock and poultry production, resulting in low resource utilization efficiency and even negative impacts on the environment. Therefore, developing a method for matching crop and livestock and poultry production in the same region based on the combination of planting and breeding is of great significance for improving the overall efficiency of agricultural production.

### SUMMARY

In view of this, the present invention provides a method for matching crop and livestock and poultry production in the same region based on the combination of planting and breeding, aiming to achieve coordinated development of crop planting and livestock and poultry breeding in the same region through scientific analysis and planning, further improve resource utilization efficiency, reduce environmental impact, and enhance the quality and yield of agricultural products.

A method for matching crop and livestock and poultry production in the same region based on a combination of planting and breeding is provided by the present invention, which includes the following steps:

determining crop varieties suitable for planting and livestock and poultry species suitable for breeding based on climate data, soil characteristics, and water resource information of an region to be matched;

determining planting and breeding plans based on physiological needs and growth cycles of the crop varieties and the livestock and poultry species;

designing a spatial layout based on the planting and breeding plans, and establishing organic connections between crops and livestock and poultry;

monitoring a growth situation of crops and livestock and poultry in real-time during the production process, and adjusting the planting and breeding plans based on the growth situation.

Preferably, the step of determining the crop varieties suitable for planting and the livestock and poultry species suitable for breeding based on climate data, soil characteristics, and water resource information of an region to be matched includes:

obtaining a comprehensive assessment result based on the climate data, the soil characteristics, and the water resource information;

a process of obtaining the comprehensive evaluation result specifically includes:

setting corresponding weight values based on various indicators in the climate data, the soil characteristics, and the water resource information;

substituting the climate data, the soil characteristics, and the water resource information of the region to be matched into an evaluation model to calculate the comprehensive evaluation result; and the comprehensive evaluation result represents a suitability of the region to be matched for different crop varieties and livestock and poultry species.

Preferably, the climate data include temperature, rainfall, and sunshine duration; the soil characteristics include soil fertilization capability and crop fertilizer demand characteristics; the water resource information includes groundwater level, water quality, and available irrigation resources.

Preferably, an establishment process of the evaluation model includes:

collecting historical data and research materials, wherein the historical data and research materials includes growth performance, yield, and health status of several crop varieties and livestock and poultry species under various climate, soil, and water resource conditions;

establishing a correlation model between growth of crop and livestock and poultry and factors of climate, soil, and water resource based on the historical data and the research materials using statistical and machine learning algorithms;

determining an accuracy and a reliability of the correlation model through model training and validation to obtain the evaluation model;

wherein the prototype model of the evaluation model is a linear regression model.

Preferably, applying the evaluation model to the comprehensive evaluation of the climate data, the soil characteristics, and the water resource information in the region to be matched to obtain a suitability ranking of different crop and livestock and poultry species in the region to be matched;

selecting top n of crop varieties and livestock and poultry species based on the suitability ranking as preliminary matching options;

obtaining an ecological complementarity of crop varieties and livestock and poultry species in the preliminary matching options, and adjusting a ranking of the preliminary matching options based on the ecological complementarity.

Preferably, a method for obtaining ecological complementarity includes:

analyzing the growth environment requirements, nutritional requirements, and waste disposal capabilities of the crop varieties and the livestock and poultry species in the preliminary matching options, and evaluating a complementary relationship formed by the crop varieties and the livestock and poultry species in an ecosystem based on analysis results;

ranking the ecological complementarity of the crop varieties and the livestock and poultry species in the preliminary matching options based on the complementary relationship, and determining a final matching combination of the crop varieties and the livestock and poultry species.

Preferably, the step of determining planting and breeding plans based on physiological needs and growth cycles of the crop varieties and the livestock and poultry species includes:

obtaining an optimal sowing time, an irrigation plan, and a fertilization plan for crops based on their growth cycle, water and fertilizer requirements;

obtaining a breeding scale and a feed ratio of livestock and poultry based on their breeding cycle, feeding density, and feed requirements.

Preferably, the step of designing a spatial layout based on the planting and breeding plans, and establishing organic connections between crops and livestock and poultry includes:

designing the spatial layout based on the optimal sowing time, the irrigation plan and the fertilization plan for crops, as well as the breeding scale and the feed ratio of livestock and poultry;

wherein specific steps of designing the spatial layout includes:

dividing land resources into a planting region and a breeding region based on terrain, landforms, and available land resources;

arranging an irrigation system in the planting region according to the growth characteristics and water demand of crops, wherein the irrigation system includes an irrigation pipe, a nozzle, and a water source; at the same time, setting up feed storage and processing facilities in the breeding region;

establishing the organic connections between crops and livestock and poultry, using livestock and poultry manure and surplus feed as organic fertilizers to provide nutrients for crops, while utilizing crop by-products as feed supplements for livestock and poultry, forming a circular agricultural ecosystem.

Preferably, the step of monitoring a growth situation of crops and livestock and poultry in real-time during the production process, and adjusting the planting and breeding plans based on the growth situation includes:

establishing a monitoring system using Internet of Things technology, then monitoring growth data of the crops and the livestock and poultry in real-time; the growth data of the crops and the livestock and poultry includes a growth rate, a leaf region index, an occurrence of pests and diseases of the crops, as well as a weight growth, a feed consumption, and a health status of the livestock and poultry;

analyzing of the monitored growth data of the crops and the livestock and poultry in real-time, utilizing big data and artificial intelligence technology to predict growth trends of the crops and the livestock and poultry, and dynamically adjusting the planting and breeding plans based on the growth trends of the crops and the livestock and poultry.

Further, the present invention provides a circular agricultural ecosystem, which is established according to the method for matching crop and livestock and poultry production in the same region based on the combination of planting and breeding mentioned above.

Compared with the related arts, the advantageous effects of the present invention are:

The present invention provides a method for matching crop and livestock and poultry production in the same region based on the combination of planting and breeding, and establishes a circular agricultural ecosystem that not only fully utilizes the climate, soil, and water resources of the region to be matched, but also fully considers the ecological complementarity between crops and livestock and poultry, achieving scientific planning and sustainable development of agricultural production.

Firstly, by comprehensively evaluating climate data, soil characteristics, and water resource information, the present invention can accurately select crop varieties and livestock and poultry species suitable for the region, thereby ensuring the smooth progress of agricultural production. Meanwhile, based on the physiological needs and growth cycles of crops and livestock and poultry, the present invention can develop scientific planting and breeding plans, maximizing resource efficiency.

Secondly, the present invention constructs a circular agricultural ecosystem by designing a reasonable spatial layout and establishing organic connections between crops and livestock and poultry. In this system, manure of livestock and poultry and surplus feed can be used as organic fertilizers to provide nutrients for crops, while crop by-products can be used as feed supplements for livestock and poultry, achieving resource recycling and a virtuous cycle of ecology.

In addition, the present invention also introduces modern technological means such as Internet of Things technology, big data, and artificial intelligence to monitor and dynamically adjust the growth of crops and livestock and poultry in real-time. This intelligent management approach not only improves the efficiency of agricultural production, but also enables timely detection and resolution of production problems, ensuring the stability and safety of agricultural production.

In summary, the method for matching crop and livestock and poultry production in the same region based on the combination of planting and breeding provided by the present invention and the establishment of a circular agricultural ecosystem not only have significant economic and ecological benefits, but also provide new ideas and methods for the modernization and sustainable development of agricultural production.

### BRIEF DESCRIPTION OF THE DRAWINGS

By reading the detailed description of the preferred embodiments in the following text, various other advantages and benefits will become clear to those skilled in the art. The accompanying drawings are only for the purpose of illustrating preferred embodiments and should not regard as limitations to the present invention. And throughout the entire figure, the same reference symbols are used to represent the same components. In the attached figure:

FIG. 1 is a flowchart of a method for matching crop and livestock and poultry production in the same region based on the combination of planting and breeding.

### DETAILED DESCRIPTION OF THE EMBODIMENTS

The exemplary embodiments of the present disclosure will be described in more detail below with reference to the accompanying drawings. Although exemplary embodiments of the present disclosure are shown in the accompanying drawings, it should be understood that the present disclosure may be implemented in various forms and should not be limited by the embodiments described herein. On the contrary, these embodiments are provided to enable a more thorough understanding of the present disclosure and to fully convey the scope of the present disclosure to those skilled in the art. It should be noted that the embodiments and features in the embodiments of the present invention can be combined with each other without conflict. The present invention will be described in detail below with reference to the accompanying drawings and in conjunction with embodiments.

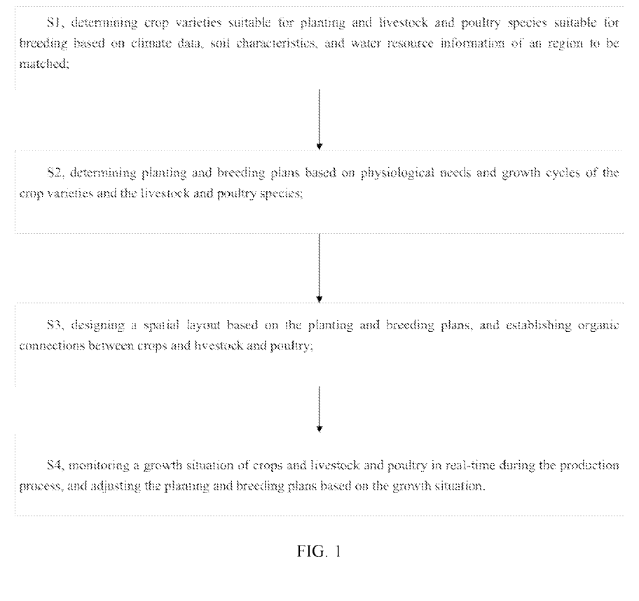

Please refer to FIG. 1, a method for matching crop and livestock and poultry production in the same region based on a combination of planting and breeding is provided in the present embodiment, which includes the following steps:

S1, determining crop varieties suitable for planting and livestock and poultry species suitable for breeding based on climate data, soil characteristics, and water resource information of an region to be matched;

S2, determining planting and breeding plans based on physiological needs and growth cycles of the crop varieties and the livestock and poultry species;

S3, designing a spatial layout based on the planting and breeding plans, and establishing organic connections between crops and livestock and poultry;

S4, monitoring a growth situation of crops and livestock and poultry in real-time during the production process, and adjusting the planting and breeding plans based on the growth situation.

It can be understood that this embodiment aims to introduce an innovative method for matching crop and livestock production in the same region based on the combination of planting and breeding. This method comprehensively considers climate conditions, soil properties, and water resources to ensure the efficiency and sustainability of agricultural production. The specific implementation steps are as follows:

Firstly, in-depth analysis is conducted based on the climate data of the region to be matched, which includes but is not limited to key indicators such as temperature, humidity, and light hours. At the same time, the detection results of soil characteristics, such as fertility level, acidity and alkalinity, drainage performance, as well as the evaluation of local water resources, are combined to comprehensively determine which crop varieties are most suitable for planting in the region. The purpose of this step is to ensure that crops can adapt to the local natural conditions to achieve optimal growth results.

Secondly, after determining the suitable crop varieties for planting, this method further considers the livestock and poultry species that match these crops. This involves a comprehensive consideration of the growth habits, food requirements, and fecal processing capabilities of different livestock and poultry. By precise matching, livestock and poultry can provide organic fertilizers to crops in the most effective way, forming a virtuous ecological cycle.

Next, based on the determined crop and livestock and poultry species, this method further develops detailed planting and breeding plans. These plans will take into account the growth cycle, the laws of fertilizer and water requirements for the crops, as well as the growth and breeding cycles of livestock and poultry, in order to arrange the order and density of planting and breeding reasonably, ensure the efficient use of land resources, and avoid resource waste and environmental pollution.

Subsequently, in implementing planting and breeding activities, this method emphasizes real-time monitoring of growth status of crop and livestock and poultry. This includes but is not limited to regular inspections of growth height, leaf color, pest and disease conditions of crops, as well as tracking of livestock and poultry weight, health status, and reproductive status. Through such monitoring, potential problems can be identified in a timely manner and measures can be taken, such as adjusting fertilization plans, improving feeding management, etc., to ensure the smooth progress of the production process.

Finally, based on the real-time monitoring results, this method also requires flexible adjustments to the established planting and breeding plans. This adjustment is based on the response to environmental changes and biological growth dynamics, aiming to maximize production efficiency while maintaining ecological balance and the sustainability of agricultural production.

In summary, the method for matching crop and livestock production in the same region based on the combination of planting and breeding proposed in this embodiment not only considers the economic benefits of agricultural production, but also takes into account the long-term goals of ecological protection and sustainable utilization of resources, with important practical significance and application value.

In some preferred embodiments of the present application, the step of determining the crop varieties suitable for planting and the livestock and poultry species suitable for breeding based on climate data, soil characteristics, and water resource information of an region to be matched includes:

obtaining a comprehensive assessment result based on the climate data, the soil characteristics, and the water resource information;

a process of obtaining the comprehensive evaluation result specifically comprises:

setting corresponding weight values based on various indicators in the climate data, the soil characteristics, and the water resource information;

substituting the climate data, the soil characteristics, and the water resource information of the region to be matched into an evaluation model to calculate the comprehensive evaluation result; and the comprehensive evaluation result represents a suitability of the region to be matched for different crop varieties and livestock and poultry species.

It can be understood that this embodiment adopts a more refined method to determine which crops and livestock and poultry species are suitable for planting and breeding in a specific region in terms of climate conditions, soil properties, and water resources. This process involves the following key steps:

Firstly, conducting a comprehensive assessment based on climate data, soil characteristics, and water resource information in the region. The goal of this step is to obtain a quantitative result that reflects the suitability of these factors for crop planting and livestock breeding.

In the process of obtaining comprehensive evaluation results, a series of specific actions were taken. This includes assigning weights to key indicators in climate data, soil characteristics, and water resources information. Weight assignment is to ensure that in comprehensive evaluation, each indicator can be appropriately reflected based on its importance.

Next, inputting the climate data, the soil characteristics, and the water resource information of the region to be matched into a refined evaluation model. Through this model, in-depth analysis of these data can be conducted, and comprehensive evaluation results can be calculated based on this.

Finally, the comprehensive evaluation results actually represent the suitability of the region to be matched for different crop and livestock and poultry species. This means that through this evaluation process, a quantitative, comprehensive, and applicable planting and breeding recommendation for this region can be obtained, thereby providing scientific basis for local agricultural production.

In some preferred embodiments of the present application, the climate data include temperature, rainfall, and sunshine duration; the soil characteristics include soil fertilization capability and crop fertilizer demand characteristics; the water resource information includes groundwater level, water quality, and available irrigation resources.

It can be understood that this embodiment particularly emphasizes some outstanding examples. In these examples, the climate data involved not only covers the basic indicator of temperature, but also includes two crucial factors for agricultural production: rainfall and sunshine duration. Specifically, changes in temperature directly affect the growth cycle and stages of crops, while sufficient rainfall and sunshine duration determine the water supply and lighting conditions of crops.

In addition, soil characteristics are also an important aspect that cannot be ignored in agricultural production. In the preferred embodiment of the present application, the soil characteristics considered include soil fertilization capability and characteristics of crop fertilizer demand. Different soils have different fertilization capabilities, which have a direct impact on the growth and yield of crops. The characteristics of crop fertilizer demand refer to the amount and duration of different nutrients required by different crops during their growth process. Understanding these characteristics can help farmers apply fertilizers reasonably during the planting process, improve crop yield and quality.

Finally, water resource information is also an indispensable part of agricultural production. In the embodiments of the present application, the water resource information includes groundwater level, water quality, and available irrigation resources. The level of groundwater directly affects the convenience and cost of irrigation, while the quality of water is related to the healthy growth of crops. The available irrigation resources determine whether the water supply for agricultural production is sufficient.

In some preferred embodiments of the present application, an establishment process of the evaluation model includes:

collecting historical data and research materials, wherein the historical data and research materials comprises growth performance, yield, and health status of several crop varieties and livestock and poultry species under various climate, soil, and water resource conditions;

establishing a correlation model between growth of crop and livestock and poultry and factors of climate, soil, and water resource based on the historical data and the research materials using statistical and machine learning algorithms;

determining an accuracy and a reliability of the correlation model through model training and validation to obtain the evaluation model;

wherein the prototype model of the evaluation model is a linear regression model.

It can be understood that the construction process of the evaluation model in this embodiment includes a series of carefully designed steps: firstly, conducting extensive collection of historical data and research materials. This step involves collecting detailed records of the growth performance, yield levels, and health status of different crop types and various livestock and poultry under diverse climatic conditions, soil characteristics, and water resource conditions. The collection of such data aims to ensure that the model can comprehensively consider various influencing factors, thereby providing a comprehensive background image for the growth of crops and livestock and poultry.

Next, based on the rich historical data and research materials collected, this embodiment adopts statistical methods and advanced machine learning algorithms to construct complex correlation models between growth of crop and livestock and poultry and their influencing factors such as climate, soil, and water resources. This process not only requires in-depth analysis of the data, but also fine tuning of the algorithm to ensure that the model can accurately capture key patterns and connections in the data.

Subsequently, through model training and rigorous validation processes, this embodiment further confirmed the accuracy and reliability of the established model. The training of the model aims to enable the model to learn and optimize its parameters in order to more accurately predict the growth of crops and livestock and poultry. The verification process is an important step in testing the generalization performance of the model, ensuring that the model can maintain stable predictive performance when facing new data.

In the construction of the evaluation model, it is worth mentioning that the prototype model is based on a linear regression model. Linear regression models have been widely used in many fields due to their concise structure and easy to understand mathematical properties. In this application, the linear regression model is transformed into a powerful tool for evaluating the growths of crop and livestock and poultry through appropriate parameter adjustments and feature engineering, making the entire evaluation model construction process both scientific and efficient.

In some preferred embodiments of the present application, applying the evaluation model to the comprehensive evaluation of the climate data, the soil characteristics, and the water resource information in the region to be matched to obtain a suitability ranking of different crop and livestock and poultry species in the region to be matched;

selecting top n of crop varieties and livestock and poultry species based on the suitability ranking as preliminary matching options;

obtaining an ecological complementarity of crop varieties and livestock and poultry species in the preliminary matching options, and adjusting a ranking of the preliminary matching options based on the ecological complementarity.

It can be understood that this embodiment adopts the evaluation model described and successfully applies it to the comprehensive evaluation of climate data, soil characteristics, and water resource information in the region to be matched. Through this evaluation process, the suitability ranking of different crop varieties and livestock and poultry species in the region is obtained, which provides important reference basis. Based on these suitability rankings, the top n crop varieties and livestock and poultry species can be selected as preliminary matching options. This step is to ensure that the selected crop varieties and livestock and poultry species can adapt to the ecological environment of the region to be matched, thereby improving the success rate of matching.

Next, obtaining the ecological complementarity information of crop varieties and livestock and poultry species from the preliminary matching options. This step is crucial because understanding their ecological complementarity can help the user better adjusts the ranking of preliminary matching options. Through this method, it can ensure that the selected crop varieties and livestock and poultry species complement each other ecologically, thereby improving the stability and productivity of the entire ecosystem. Overall, by applying the evaluation model to the comprehensive assessment of climate data, soil characteristics, and water resource information in the region to be matched, and adjusting the preliminary matching options based on suitability ranking and ecological complementarity, it can more effectively achieve the matching of crop varieties and livestock and poultry species, thereby improving the effectiveness of agricultural production.

In some preferred embodiments of the present application, a method for obtaining ecological complementarity includes:

analyzing the growth environment requirements, nutritional requirements, and waste disposal capabilities of the crop varieties and the livestock and poultry species in the preliminary matching options, and evaluating a complementary relationship formed by the crop varieties and the livestock and poultry species in an ecosystem based on analysis results;

ranking the ecological complementarity of the crop varieties and the livestock and poultry species in the preliminary matching options based on the complementary relationship, and determining a final matching combination of the crop varieties and the livestock and poultry species.

It can be understood that the method for obtaining ecological complementarity described in this embodiment includes the following steps:

Firstly, conducting an in-depth analysis of the growth environment requirements, nutritional needs, and waste disposal capabilities of the crop varieties and livestock and poultry species in the preliminary matching options. This step requires comprehensive consideration of various factors, such as the requirements of crop varieties for environmental factors such as soil, water, and climate, as well as the demands of livestock and poultry species for feed and feeding environment. At the same time, it is necessary to evaluate the ability of various crop varieties and livestock and poultry species in waste management, such as whether they can effectively utilize waste from each other as fertilizer.

Then, based on the analysis results, evaluating the complementary relationship formed between crop varieties and livestock and poultry species in the ecosystem among the preliminary matching options. This step requires evaluating the interactions between various crop varieties and livestock and poultry species based on the previous analysis results, such as certain crops providing feed for livestock and poultry, and manure of livestock and poultry serving as fertilizer for these crops, forming a healthy ecosystem.

Next, based on the complementary relationship, ranking the ecological complementarity of crop varieties and livestock and poultry species in the preliminary matching options. This step requires quantifying or scoring the previous analysis results to determine the degree of ecological complementarity between various crop varieties and livestock and poultry species, in order to facilitate subsequent matching.

Finally, determining the final matching combination of crop varieties and livestock and poultry species. This step requires selecting the combination of crop varieties and livestock and poultry species with the highest degree of complementarity based on the previous ranking results, in order to achieve the best ecological complementarity effect.

In some preferred embodiments of the present application, the step of determining planting and breeding plans based on physiological needs and growth cycles of the crop varieties and the livestock and poultry species includes:

obtaining an optimal sowing time, an irrigation plan, and a fertilization plan for crops based on their growth cycle, water and fertilizer requirements;

obtaining a breeding scale and a feed ratio of livestock and poultry based on their breeding cycle, feeding density, and feed requirements.

It can be understood that in order to fully meet the specific physiological needs of different crop varieties and livestock and poultry species, as well as their unique growth cycles, it is crucial to develop accurate planting and breeding plans in this embodiment. The specific planning process includes the following aspects:

Firstly, based on the specific growth characteristics of different crops, such as growth cycle, water and fertilizer requirements, the most suitable sowing time for each crop is determined through scientific analysis and calculation. The purpose of this step is to ensure that crops can start growing under the most favorable seasons and climatic conditions, thereby fully utilizing natural environmental resources and improving yield and quality.

Secondly, in the formulation of irrigation plans, a reasonable water management plan should be designed based on the water demand characteristics of crops and soil water retention capacity. This not only involves the frequency and timing of irrigation, but also the control of irrigation amount to ensure that the water requirements of crops are met at various growth stages, and to prevent excessive or insufficient water from having adverse effects on crop growth.

Next, for the fertilization plan, the embodiment of this application will comprehensively consider the different nutrient demands of crops, as well as the soil fertility and nutrient status, and develop a scientific fertilization strategy. This includes determining the type, timing, and amount of fertilization to ensure that crops receive sufficient nutrition at all stages of growth, promoting their healthy and robust growth.

In terms of livestock and poultry breeding, the appropriate breeding scale will be determined in the embodiment based on the reproductive cycle characteristics of different livestock and poultry species, as well as the density effect and feed conversion efficiency in the breeding environment. This decision-making process needs to take into account the demand of livestock and poultry for different feed components to ensure that the supply of feed can meet the nutritional needs of livestock and poultry while also being economically efficient.

In summary, this application has developed a detailed and scientific planting and breeding plan by comprehensively considering the physiological needs and growth cycle characteristics of crop varieties and livestock and poultry species, aiming to improve agricultural production efficiency, optimize resource allocation, and achieve sustainable agricultural development. This embodiment not only improves the yield and quality of agricultural products, but also reduces production costs.

In some preferred embodiments of the present application, the step of designing a spatial layout based on the planting and breeding plans, and establishing organic connections between crops and livestock and poultry includes:

designing the spatial layout based on the optimal sowing time, the irrigation plan and the fertilization plan for crops, as well as the breeding scale and the feed ratio of livestock and poultry;

wherein specific steps of designing the spatial layout comprises:

dividing land resources into a planting region and a breeding region based on terrain, landforms, and available land resources;

arranging an irrigation system in the planting region according to the growth characteristics and water demand of crops, wherein the irrigation system comprises an irrigation pipe, a nozzle, and a water source; at the same time, setting up feed storage and processing facilities in the breeding region;

establishing the organic connections between crops and livestock and poultry, using livestock and poultry manure and surplus feed as organic fertilizers to provide nutrients for crops, while utilizing crop by-products as feed supplements for livestock and poultry, forming a circular agricultural ecosystem.

It can be understood that in order to achieve efficient and sustainable agricultural production, this embodiment carefully designs the spatial layout based on specific planting and breeding plans, and constructs an organic connection between crops and livestock and poultry. This process mainly includes the following aspects:

Firstly, it need to consider the optimal sowing time, irrigation solution, and fertilization plan for crops, as well as the breeding scale and feed ratio of livestock and poultry, which will have a significant impact on spatial layout. For example, for crops that require a large amount of water, it should arrange sufficient irrigation facilities during their growth cycle; For livestock and poultry that require specific feed ratios, it also need to equip corresponding feed storage and processing facilities in their breeding areas.

Secondly, the method of designing spatial layout mainly includes a detailed investigation of terrain, landforms, and available land resources, based on which the planting and breeding areas are divided into zones. This division not only helps to improve agricultural production efficiency, but also enables the development of more scientific and reasonable agricultural production plans based on the actual situation of different regions.

In the planting region, it also need to arrange irrigation systems based on the growth characteristics and water requirements of crops. This system usually includes an irrigation pipe, a nozzle, and a water source, and its main function is to provide sufficient water for crops to ensure their normal growth. At the same time, in the breeding region, it also need to set up feed storage and processing facilities to ensure the supply of feed for livestock and poultry.

Finally, it also need to establish an organic connections between crops and livestock and poultry, forming a circular agricultural ecosystem. Specifically, it can use animal manure and leftover feed as organic fertilizers to provide nutrients for crops. At the same time, it can also use crop by-products as feed supplements for livestock and poultry. In this way, a good interactive relationship is formed between crops and livestock and poultry, which not only improves the efficiency of resource utilization but also achieves sustainable development of agricultural production.

In some preferred embodiments of the present application, the step of monitoring a growth situation of crops and livestock and poultry in real-time during the production process, and adjusting the planting and breeding plans based on the growth situation includes:

establishing a monitoring system using Internet of Things (IoT) technology, then monitoring growth data of the crops and the livestock and poultry in real-time; the growth data of the crops and the livestock and poultry comprises a growth rate, a leaf region index, an occurrence of pests and diseases of the crops, as well as a weight growth, a feed consumption, and a health status of the livestock and poultry;

analyzing of the monitored growth data of the crops and the livestock and poultry in real-time, utilizing big data and artificial intelligence technology to predict growth trends of the crops and the livestock and poultry, and dynamically adjusting the planting and breeding plans based on the growth trends of the crops and the livestock and poultry.

It can be understood that this embodiment particularly emphasizes some outstanding embodiments, which are mainly reflected in the production process, how to track and monitor the growth status of crops, livestock and poultry in real-time, and flexibly adjust the planting and breeding plans according to their growth status. Specifically, this process includes the following important steps:

Firstly, constructing a comprehensive monitoring system based on advanced IoT technology. The main function of this system is to collect and record real-time growth data of crops, livestock, and poultry. These growth data comprehensively reflect various growth indicators of crops, such as growth rate, leaf region index, and the occurrence of pests and diseases. For livestock and poultry, monitoring systems will collect information on their weight gain, feed consumption, and health status.

Next, conducting real-time analysis and processing of the collected growth data. In this process, large-scale data analysis and artificial intelligence technology are used to predict the growth trends of crops and livestock and poultry. Through this method, it is possible to more accurately predict their future growth status, providing strong data support for adjusting planting and breeding plans.

Finally, based on the predicted growth trend, conducting dynamic adjustments to the existing planting and breeding plans. This adjustment is real-time and flexible, ensuring that the production plan always matches the actual growth status of crops and the actual needs of livestock and poultry. In this way, not only can production efficiency be improved, but the quality and safety of agricultural and livestock products can also be ensured.

Overall, through this series of technological means and production management strategies, it is possible to achieve refined management and intelligent control of the agricultural production process, which not only improves agricultural production efficiency, but also effectively enhances the sustainability of agricultural production.

Further, a circular agricultural ecosystem is provided by the present invention wherein the circular agricultural ecosystem is established according to the method for matching crop and livestock and poultry production in the same region based on the combination of planting and breeding mentioned above.

It can be understood that this embodiment also provides a circular agricultural ecosystem, which is unique in that it is established based on the method for matching crop and livestock and poultry production in the same region through the combination of planting and breeding mentioned above. This ecosystem fully utilizes resources and optimizes agricultural production methods. Through scientific planning and rational arrangement, crop planting and livestock and poultry breeding form a virtuous cycle in a region, promoting each other and improving agricultural production efficiency, while also reducing environmental pollution.

The skilled person in the art should understand that the embodiments of the present application can be provided as methods, systems, or computer program products. Therefore, this application can adopt the form of a fully hardware implementation, a fully software implementation, or a combination of software and hardware implementation. Moreover, the present application may take the form of a computer program commodity implemented on one or more computer usable storage media (including but not limited to disk storage, CD-ROM, optical storage, etc.) containing computer usable program code.

This application is described with reference to the flowchart and/or block diagram of the method, device (system), and computer program product according to the embodiments of this application. It should be understood that each process and/or block in the flowchart and/or block diagram can be implemented by computer program instructions, as well as the combination of processes and/or blocks in the flowchart and/or block diagram. These computer program instructions can be provided to a processor of a general-purpose computer, specialized computer, embedded processor, or other programmable data processing device to generate a machine, such that the instructions executed by the processor of the computer or other programmable data processing device generate a device for implementing the functions specified in one or more processes in the flowchart and/or one or more boxes in the block diagram.

These computer program instructions can also be stored in computer-readable memory that can guide a computer or other programmable data processing device to operate in a specific manner, causing the instructions stored in the computer-readable memory to produce a manufactured product including instruction devices that implement the functions specified in one or more processes in the flowchart and/or one or more blocks in the block diagram.

These computer program instructions can also be loaded onto a computer or other programmable data processing device, enabling a series of operational steps to be executed on the computer or other programmable device to generate computer implemented processing. Thus, the instructions executed on the computer or other programmable device provide steps for implementing the functions specified in one or more processes in the flowchart and/or one or more blocks in the block diagram.

Finally, it should be noted that the above embodiments are only used to illustrate the technical solution of the present invention and not to limit it. Although the present invention has been described in detail with reference to the above embodiments, those skilled in the art should understand that modifications or equivalent substitutions can still be made to the specific embodiments of the present invention, and any modifications or equivalent substitutions that do not depart from the spirit and scope of the present invention should be covered within the scope of the claims of the present invention.

1. A method for matching crop and livestock and poultry production in the same region based on a combination of planting and breeding, comprising:
determining crop varieties suitable for planting and livestock and poultry species suitable for breeding based on climate data, soil characteristics, and water resource information of an region to be matched;
determining planting and breeding plans based on physiological needs and growth cycles of the crop varieties and the livestock and poultry species;
designing a spatial layout based on the planting and breeding plans, and establishing organic connections between crops and livestock and poultry;
monitoring a growth situation of crops and livestock and poultry in real-time during the production process, and adjusting the planting and breeding plans based on the growth situation.

2. The method for matching crop and livestock and poultry production in the same region based on the combination of planting and breeding according to claim 1, wherein the step of determining the crop varieties suitable for planting and the livestock and poultry species suitable for breeding based on climate data, soil characteristics, and water resource information of an region to be matched comprises:
obtaining a comprehensive assessment result based on the climate data, the soil characteristics, and the water resource information;
a process of obtaining the comprehensive evaluation result specifically comprises:
setting corresponding weight values based on various indicators in the climate data, the soil characteristics, and the water resource information;
substituting the climate data, the soil characteristics, and the water resource information of the region to be matched into an evaluation model to calculate the comprehensive evaluation result; and the comprehensive evaluation result represents a suitability of the region to be matched for different crop varieties and livestock and poultry species.

3. The method for matching crop and livestock and poultry production in the same region based on the combination of planting and breeding according to claim 2, wherein the climate data comprise temperature, rainfall, and sunshine duration; the soil characteristics comprise soil fertilization capability and crop fertilizer demand characteristics; the water resource information comprises groundwater level, water quality, and available irrigation resources.

4. The method for matching crop and livestock and poultry production in the same region based on the combination of planting and breeding according to claim 3, wherein an establishment process of the evaluation model comprises:
collecting historical data and research materials, wherein the historical data and research materials comprises growth performance, yield, and health status of several crop varieties and livestock and poultry species under various climate, soil, and water resource conditions;
establishing a correlation model between growth of crop and livestock and poultry and factors of climate, soil, and water resource based on the historical data and the research materials using statistical and machine learning algorithms;
determining an accuracy and a reliability of the correlation model through model training and validation to obtain the evaluation model;
wherein the prototype model of the evaluation model is a linear regression model.

5. The method for matching crop and livestock and poultry production in the same region based on the combination of planting and breeding according to claim 4, wherein applying the evaluation model to the comprehensive evaluation of the climate data, the soil characteristics, and the water resource information in the region to be matched to obtain a suitability ranking of different crop and livestock and poultry species in the region to be matched;
selecting top n of crop varieties and livestock and poultry species based on the suitability ranking as preliminary matching options;
obtaining an ecological complementarity of crop varieties and livestock and poultry species in the preliminary matching options, and adjusting a ranking of the preliminary matching options based on the ecological complementarity.

6. The method for matching crop and livestock and poultry production in the same region based on the combination of planting and breeding according to claim 5, wherein a method for obtaining ecological complementarity comprises:
analyzing the growth environment requirements, nutritional requirements, and waste disposal capabilities of the crop varieties and the livestock and poultry species in the preliminary matching options, and evaluating a complementary relationship formed by the crop varieties and the livestock and poultry species in an ecosystem based on analysis results;
ranking the ecological complementarity of the crop varieties and the livestock and poultry species in the preliminary matching options based on the complementary relationship, and determining a final matching combination of the crop varieties and the livestock and poultry species.

7. The method for matching crop and livestock and poultry production in the same region based on the combination of planting and breeding according to claim 1, wherein the step of determining planting and breeding plans based on physiological needs and growth cycles of the crop varieties and the livestock and poultry species comprises:
obtaining an optimal sowing time, an irrigation plan, and a fertilization plan for crops based on their growth cycle, water and fertilizer requirements;
obtaining a breeding scale and a feed ratio of livestock and poultry based on their breeding cycle, feeding density, and feed requirements.

8. The method for matching crop and livestock and poultry production in the same region based on the combination of planting and breeding according to claim 7, wherein the step of designing a spatial layout based on the planting and breeding plans, and establishing organic connections between crops and livestock and poultry comprises:
designing the spatial layout based on the optimal sowing time, the irrigation plan and the fertilization plan for crops, as well as the breeding scale and the feed ratio of livestock and poultry;
wherein specific steps of designing the spatial layout comprises:
dividing land resources into a planting region and a breeding region based on terrain, landforms, and available land resources;
arranging an irrigation system in the planting region according to the growth characteristics and water demand of crops, wherein the irrigation system comprises an irrigation pipe, a nozzle, and a water source; at the same time, setting up feed storage and processing facilities in the breeding region;
establishing the organic connections between crops and livestock and poultry, using livestock and poultry manure and surplus feed as organic fertilizers to provide nutrients for crops, while utilizing crop by-products as feed supplements for livestock and poultry, forming a circular agricultural ecosystem.

9. The method for matching crop and livestock and poultry production in the same region based on the combination of planting and breeding according to claim 1, wherein the step of monitoring a growth situation of crops and livestock and poultry in real-time during the production process, and adjusting the planting and breeding plans based on the growth situation comprises:
establishing a monitoring system using Internet of Things technology, then monitoring growth data of the crops and the livestock and poultry in real-time; the growth data of the crops and the livestock and poultry comprises a growth rate, a leaf region index, an occurrence of pests and diseases of the crops, as well as a weight growth, a feed consumption, and a health status of the livestock and poultry;
analyzing of the monitored growth data of the crops and the livestock and poultry in real-time, utilizing big data and artificial intelligence technology to predict growth trends of the crops and the livestock and poultry, and dynamically adjusting the planting and breeding plans based on the growth trends of the crops and the livestock and poultry.

10. A circular agricultural ecosystem, characterized in that, wherein the circular agricultural ecosystem is established according to the method for matching crop and livestock and poultry production in the same region based on the combination of planting and breeding as claimed in claim 1.
